(19) United States
(12) Patent Application Publication
(10) Pub. No.: US 2017/0162964 A1
(43) Pub. Date: Jun. 8, 2017

(54) CARD EDGE CONNECTORS

(71) Applicant: International Business Machines Corporation, Armonk, NY (US)

(72) Inventor: Lei Shan, Carmel, NY (US)

(21) Appl. No.: 14/962,035

(22) Filed: Dec. 8, 2015

(51) Int. Cl. H01R 12/72

(52) U.S. Cl. CPC H01R 12/721

(57) ABSTRACT

An apparatus includes a connector housing having a card edge channel and a connector pin channel formed therein, the connector pin channel comprising a front portion that is immediately adjacent to the card edge channel and a back portion that is proximate to a back wall of the connector pin channel, and a connector pin disposed within the connector pin channel. The connector pin includes a rising portion disposed within the back portion of the connector pin channel, and a curved portion that connects the rising portion to a deflectable descending portion. The deflectable descending portion may comprise a contacting portion that protrudes outside of the connector pin channel when a card is not inserted into the card edge channel. A corresponding system is also disclosed herein.

### BACKGROUND OF THE INVENTION

The present invention relates generally to the field of electrical connectors, and more particularly to card edge connectors.

Card edge connectors are used to receive a circuit card such as a memory module or I/O device and provide electrical connectivity to components on the circuit board on which the card edge connector is mounted. Consequently, the signal bandwidth provided by card edge connectors may be a limiting factor in system performance.

### SUMMARY

An apparatus includes a connector housing having a card edge channel and a connector pin channel formed therein, the connector pin channel comprising a front portion that is immediately adjacent to the card edge channel and a back portion that is proximate to a back wall of the connector pin channel, and a connector pin disposed within the connector pin channel. The connector pin includes a rising portion disposed within the back portion of the connector pin channel, and a curved portion that connects the rising portion to a deflectable descending portion. The deflectable descending portion may comprise a contacting portion that protrudes outside of the connector pin channel when a card is not inserted into the card edge channel.

A corresponding system includes the above apparatus and one or more elements of a computing system such as a processor, a memory, and an I/O device.

### BRIEF DESCRIPTION OF THE DRAWINGS

FIG. 1 is a graph depicting one example of the frequency response associated with currently available card edge connectors;

FIGS. 2, 3, 4, and 5 are, respectively, perspective view, side view, top view, and end view drawings depicting one example of an card edge connector in accordance with at least one embodiment of the present invention;

FIG. 6 is a perspective view drawing depicting a first example of a connector pin in accordance with at least one embodiment of the present invention;

FIG. 7 is a perspective view drawing depicting a second example of a connector pin in accordance with at least one embodiment of the present invention;

FIG. 8 is a perspective view drawing depicting one example of a prior art connector pin; and

FIG. 9 is a graph comparing the frequency response of one example of the present invention with the frequency response of currently available card edge connectors.

### DETAILED DESCRIPTION

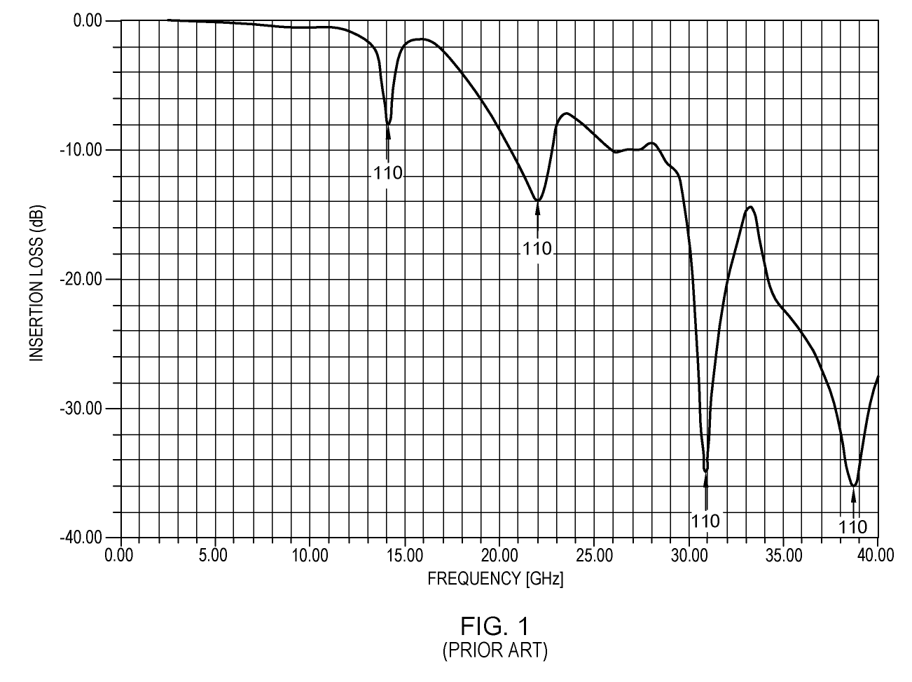

The embodiments disclosed herein recognize that the electrical and electromagnetic characteristics of card edge connectors (e.g., PCIe and DIMM) are a limiting factor for data throughput in computing systems. For example, as shown in FIG. 1 the parasitic inductance and capacitance of existing card edge connectors typically creates undesired circuit resonances 110 at frequencies between 12 and 40 GHz and thereby limits data throughputs to approximately 16 Gbps.

The embodiments disclosed herein also recognize that the point of contact on the connector pins of existing card edge connectors may result in “pin stubs” that are ancillary to the signal propagation path of card edge connectors. Such stubs may provide parasitic inductance and capacitance as well as unwanted signal reflections.

Various embodiments of the present invention will now be described in reference to the Figures. The embodiments disclosed herein address at least some of the above issues.

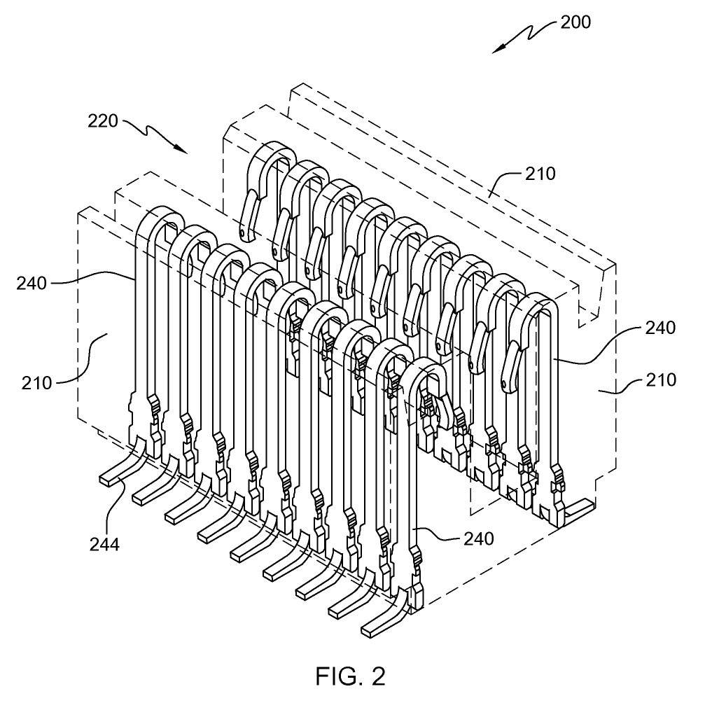

For example, FIGS. 2, 3, 4, and 5 are, respectively, perspective view, side view, top view, and end view drawings depicting one example of an card edge connector 200 in accordance with at least one embodiment of the present invention. As depicted, the card edge connector 200 includes a housing 210 (transparently shown with dashed lines) with a card edge channel 220 and connector pin channels 230 (not shown in FIG. 2) formed therein. The depicted card edge connector 200 also includes a set of connector pins 240. The card edge connector 200 provides electrical connectivity between a card edge device such as a dual in-line memory module (DIMM) and a printed circuit board such as a motherboard.

The card edge channel 220 enables insertion of a card edge of a circuit card (not shown) into the housing 210 in order to provide physical contact and an electrical connection between connection pads (e.g., fingers) on the inserted circuit card and a contacting portion 241 of the connector pins 240. As shown in FIGS. 3 and 4, the contacting portion 241 may protrude outside of the connector pin channel 230, within which the connector pin 240 resides, and into the card edge channel 230, when a card is not present in the card edge channel 230. By protruding outside of the connector pin channel and into the card edge channel 220, the contacting portion 241 may establish contact with the connection pads of a card that is inserted into the card edge channel 220.

Referring at least to FIG. 5, each connector pin channel 230 may comprise a front portion 232 that is immediately adjacent to the card edge channel 220 and a back portion 234 that is immediately adjacent to a back wall 236 of the connector pin channel 230. In the depicted embodiments, the connector pins 240 include a mating portion 242 that mates the connector pin 240 with the housing 210. In some embodiments, the housing 210 includes a corresponding mating portion (not specifically shown) that enables locking the connector pin 240 into the connector pin channel 230.

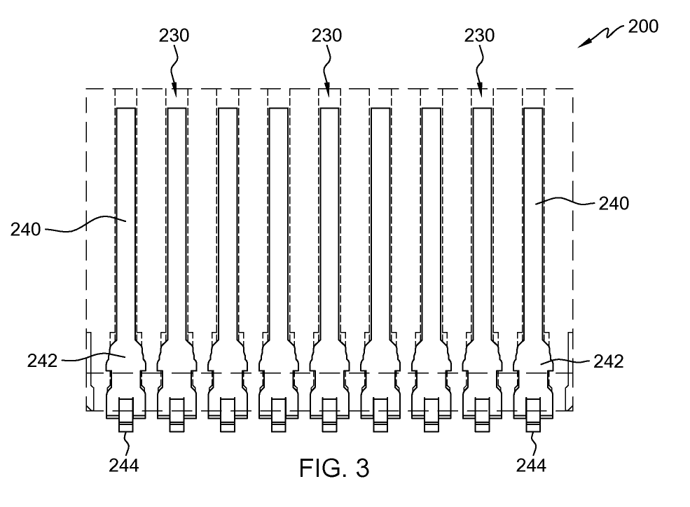

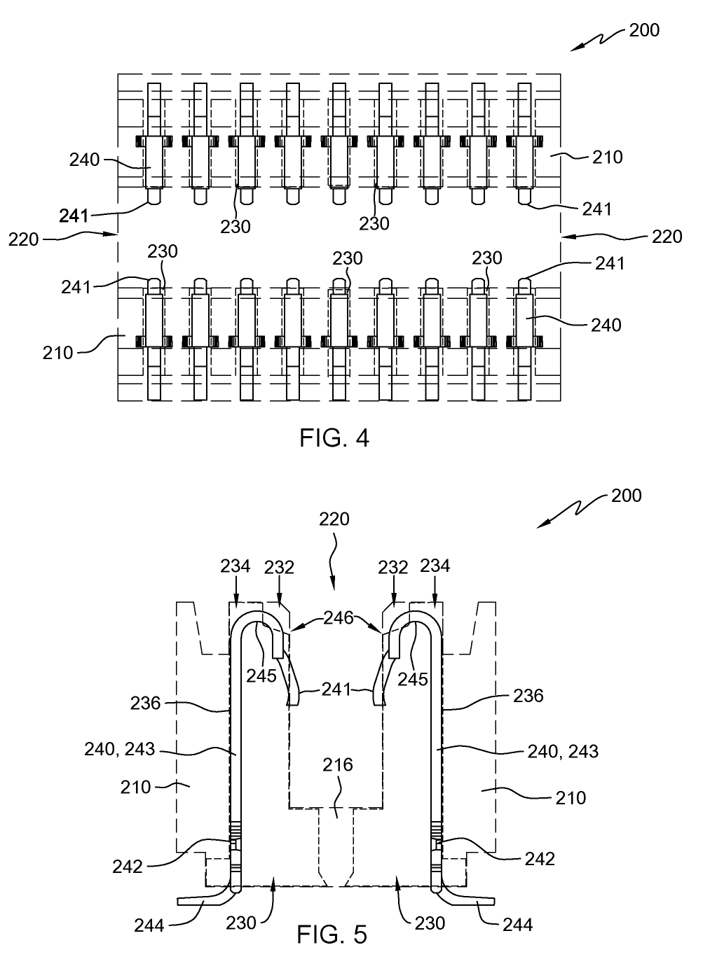

FIGS. 6 and 7 are perspective view drawings depicting respective first and second examples of the connector pin 240 (i.e., 240A and 240B) in accordance with at least one embodiment of the present invention. FIG. 6A depicts a surface mount connector pin 240A and FIG. 6B depicts a through hole connector pin 240B. Referring to FIGS. 6 and 7 while continuing to refer to FIGS. 2-5, the connector pins 240 include a rising portion 243 disposed within the back portion 234 of the connector pin channel 230 that rises from a mounting portion 244. In the embodiments depicted in FIGS. 2-5, the rising portion 243 is immediately adjacent to and parallel with the back wall 236 of the connector pin channel 230.

The mounting portion 244 enables mounting the card edge connector 200 on a printed circuit board, or the like, and providing an electrical connection thereto. In the embodiment depicted in FIG. 6, the mounting portion 244 enables surface mounting the card edge connector 200. In the embodiment depicted in FIG. 7, the mounting portion 244 enables through hole mounting of the card edge connector 200.

Each depicted connector pin 240 (i.e., 240A and 240B) also includes a curved portion 245 that connects the rising portion 243 to a deflectable descending portion 246. The rising portion 243, the curved portion 245, and the deflectable descending portion 246 form a hook-like shape for the connector pins 240.

The deflectable descending portion 246 of each depicted connector pin 240 includes the contacting portion 241 that protrudes outside of the connector pin channel 230 when a card is not present in the card edge channel 220. The depicting contacting portion 241 is not as wide as the rest of the depicted connector pin 240 resulting in a reduced insertion force for the card edge connector 200. Furthermore, the depicting contacting portion 241 is proximate to one end of the connector pin 240 and thereby substantially eliminates the ill effects of a pin stub that is present in many conventional card edge connectors.

In addition to the “pin-stub” resonance removal, signal loss through the card edge connector 200 may be further reduced by tuning the dielectric constant of the connector housing 210 so that each connector pin 240 disposed within a connector pin channel 230 provides a selected constant impedance to a signal. Impedances from less than 10 ohms to greater that 300 ohms are attainable. As signal waves propagate along the connector pins 240 and through the connector pin channels 230, a constant impedance minimizes reflections (return loss), which not only helps retain waveform integrity but also reduces insertion loss. The reflection coefficient is given by:

R=(ZL−ZS)/(ZL+ZS) (1)

where ZL and ZS are load and source impedances. Reflections may be substantially eliminated when ZL and ZS are matched (ZL=ZS). Source impedance is usually defined and fixed with system designs, and load (connector) impedance can be expressed as:

$${Z}_{0} = \sqrt{\frac{R + jwL}{G + jwC}} \qquad ( 2 )$$

For a given connector structure, by adjusting the dielectric constant of the housing 210, the shunt capacitance C may be increased/decreased to achieve the desired impedance. In case of conventional PCIe and DIMM connectors, single-ended/differential impedance is usually higher than normal system impedance of 50 to 100 ohm, in its original form, which tends to introduce additional insertion and return losses. Therefore, since the impedance is inversely related to the capacitance C, the dielectric constant of the housing 210 may be increased in order to increase shunt capacitance C and reduce the impedance to match a 10 to 300 ohm system including the normal system impedance of 50 to 100 ohm.

Dielectric constant adjustment of the housing 210 can be achieved by the addition of high dielectric constant ceramic particles into the connector housing material which varies the effective dielectric constant of the housing. The increase in dielectric constant of the connector housing helps bring down the pin-to-pin impedance into the 50 to 100 ohm system impedance range, and therefore helps reduce insertion and return losses.

The dielectric constant of the particle-resin compound in the housing 210 may be determined using Looyenga's formula:

∈=[∈₁^{1/3}+ν₂(∈₂^{1/3}−∈₁^{1/3})]³ (3)

where, ∈₁ is the dielectric constant of the carrier material, and ∈₂ and ν₂ are the dielectric constant and volume fraction of the ceramic particles. As an example, SrTiO3 powder has a dielectric constant of 300, and a K=16 dielectric compound may be obtained by adding 20% SrTiO3 powder into the connector housing carrier material. The particle size may range from nanometers to micrometers. Generally, smaller particle size allows greater particle volume fraction as well as better compound stability. In some instances, a bi-modal (two particle sizes) or multi-modal powder may be used for maximum particle volume fraction. The mechanical properties and stability of the resulting housing should be similar to its original form, since it is a common process to add particles (normally silica) and pigment into connector housing for desired mechanical properties.

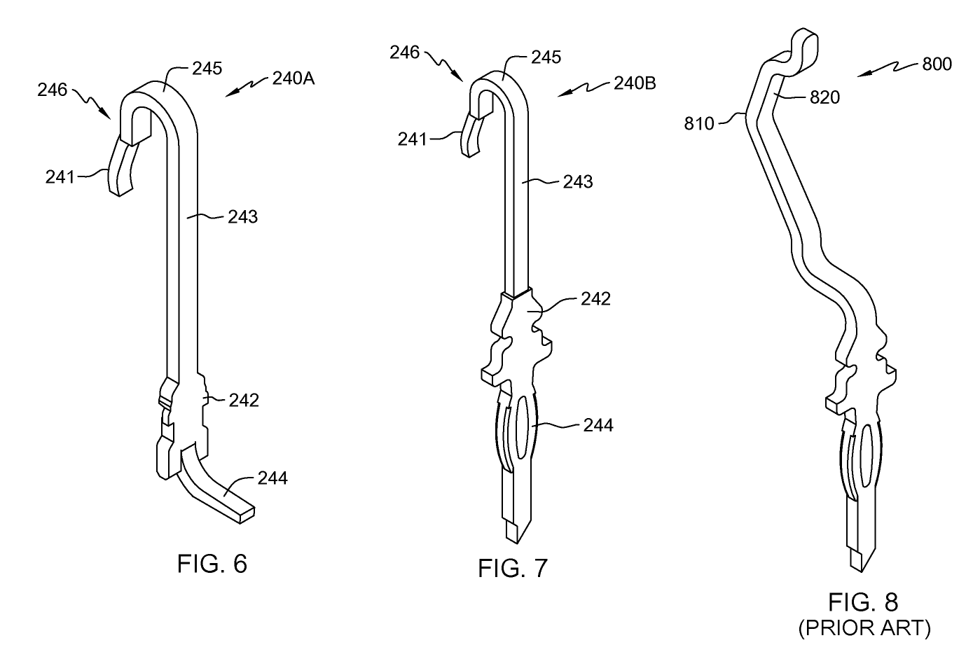

FIG. 8 is a perspective view drawing depicting one example of a prior art connector pin 800. As depicted, the prior art connector pin 800 includes a contact portion 810 that enables contact with connection pads on a card edge (not shown). However, due to the placement of the contact portion 810, providing contact with a connection pad results in a stub 820 that provides parasitic capacitance and inductance to a signal pathway provided by the connector pin 800 resulting in the resonances 110 shown in FIG. 1.

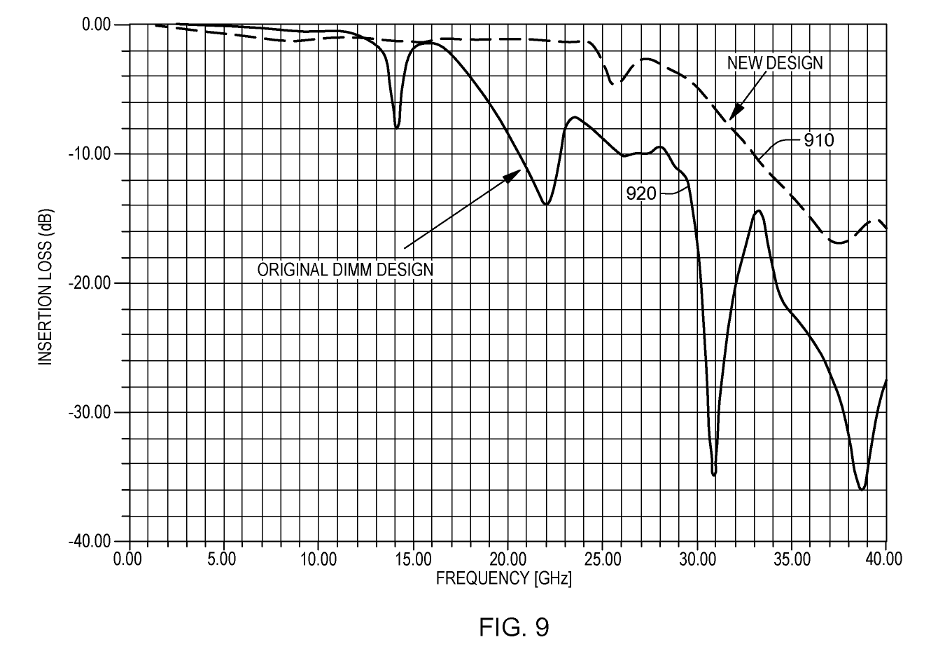

FIG. 9 is a graph comparing the frequency response 910 of one example of the present invention with the typical frequency response 920 of currently available card edge connectors that use the prior art connector pin 800. One of skill in the art will appreciate that the elimination of stubs in the connection pins 240 and associated parasitic capacitance and inductance substantially eliminates circuit resonances in the 12 to 40 GHz range and greatly reduces the insertion loss that is attainable with the card edge connector 200. For example, the depicted frequency response supports the transmission of 12 GHz to 24 GHz signals with a loss of less than 2 dB and can support data rates of greater than 30 Gbps.

It should be noted that this description is not intended to limit the invention. On the contrary, the embodiments presented are intended to cover some of the alternatives, modifications, and equivalents, which are included in the spirit and scope of the invention as defined by the appended claims. Further, in the detailed description of the disclosed embodiments, numerous specific details are set forth in order to provide a comprehensive understanding of the claimed invention. However, one skilled in the art would understand that various embodiments may be practiced without such specific details.

Although the features and elements of the embodiments disclosed herein are described in particular combinations, each feature or element can be used alone without the other features and elements of the embodiments or in various combinations with or without other features and elements disclosed herein.

This written description uses examples of the subject matter disclosed to enable any person skilled in the art to practice the same, including making and using any devices or systems and performing any incorporated methods. The patentable scope of the subject matter is defined by the claims, and may include other examples that occur to those skilled in the art. Such other examples are intended to be within the scope of the claims.

1. An apparatus comprising:
a connector housing having a card edge channel and a connector pin channel formed therein, the connector pin channel comprising a front portion that is immediately adjacent to the card edge channel and a back portion that is proximate to a back wall of the connector pin channel;
a connector pin disposed within the connector pin channel, the connector pin comprising a rising portion disposed within the back portion of the connector pin channel, and a curved portion that connects the rising portion to a deflectable descending portion;
wherein the deflectable descending portion comprises a contacting portion that protrudes outside of the connector pin channel when a card is not inserted into the card edge channel;
wherein the contacting portion is immediately proximate to one end of the connector pin; and
wherein the deflectable descending portion including the contacting portion is thinner than the entirety of the rising portion and the entirety of the curved portion.

2. The apparatus of claim 1, wherein the connector pin disposed within the connector pin channel supports transmission of a 16 GHz signal with a loss of less than 2 dB.

3. The apparatus of claim 2, wherein the connector pin disposed within the connector pin channel supports a data rate of 32 Gbps.

4. The apparatus of claim 2, wherein the connector pin disposed within the connector pin channel supports transmission of a 24 GHz signal with a loss of less than 2 dB.

5. The apparatus of claim 1, wherein the connector housing is formed of a material with a dielectric constant that is greater than 2.

6. The apparatus of claim 1, wherein the connector housing is formed of a material comprising ceramic particles.

7. The apparatus of claim 6, wherein the ceramic particles have a dielectric constant that is greater than 4.

8. The apparatus of claim 1, wherein the connector pin disposed within the connector pin channel has a signal impedance of less than 300 ohms and greater than 10 ohms.

9. The apparatus of claim 1, wherein the rising portion connects to a mounting portion.

10. The apparatus of claim 1, wherein the rising portion is substantially parallel with the back wall of the connector pin channel.

11. The apparatus of claim 1, wherein the rising portion, the curved portion, and the deflectable descending portion form a hook-like shape.

12. The apparatus of claim 1, further comprising a second connector pin channel disposed adjacent to the card edge channel and opposite the connector pin channel.

13. The apparatus of claim 12, further comprising a second connector pin disposed within the second connector pin channel, the second connector pin comprising a rising portion disposed within a back portion of the second connector pin channel, a deflectable descending portion, and a curved portion that connects the rising portion to the deflectable descending portion, the deflectable descending portion comprising a contacting portion that protrudes outside of the second connector pin channel when a card is not inserted into the card edge channel.

14. A system comprising:
a processor;
a memory;
an I/O device; and
at least one connector comprising:
a connector housing having a card edge channel and a connector pin channel formed therein, the connector pin channel comprising a front portion that is immediately adjacent to the card edge channel and a back portion that is proximate to a back wall of the connector pin channel,
a connector pin disposed within the connector pin channel, the connector pin comprising a rising portion disposed within the back portion of the connector pin channel, and a curved portion that connects the rising portion to a deflectable descending portion,
wherein the deflectable descending portion comprises a contacting portion that protrudes outside of the connector pin channel when a card is not inserted into the card edge channel,
wherein the contacting portion is immediately proximate to one end of the connector pin, and
wherein the deflectable descending portion including the contacting portion is thinner than the entirety of the rising portion and the entirety of the curved portion.

15. The system of claim 14, wherein the rising portion, the curved portion, and the deflectable descending portion form a hook-like shape.

16. The system of claim 14, wherein the rising portion is substantially parallel with the back wall of the connector pin channel.

17. The system of claim 14, further comprising a second connector pin channel disposed adjacent to the card edge channel and opposite the connector pin channel.

18. The system of claim 17, further comprising a second connector pin disposed within the second connector pin channel, the second connector pin comprising a rising portion disposed within a back portion of the second connector pin channel, a deflectable descending portion, and a curved portion that connects the rising portion to the deflectable descending portion, the deflectable descending portion comprising a contacting portion that protrudes outside of the second connector pin channel when a card is not inserted into the card edge channel.

19. The system of claim 14, wherein the connector pin disposed within the connector pin channel supports transmission of a 16 GHz signal with a loss of less than 2 dB.

20. The system of claim 19, wherein the connector pin disposed within the connector pin channel supports a data rate of 32 Gbps.
